(19) United States
(12) Patent Application Publication
(10) Pub. No.: US 2007/0223316 A1
(43) Pub. Date: Sep. 27, 2007

(54) Watch Displaying the Date and Indicating Astronomical Information

(75) Inventors: Jean-Jacques Born, Morges (CH); Jean Laurent, Blonay (CH)

Correspondence Address: GRIFFIN & SZIPL, PC, SUITE PH-1, 2300 NINTH STREET, SOUTH, ARLINGTON, VA, 22204, US

(73) Assignee: Asulab S.A., Marin (CH)

(21) Appl. No.: 11/572,934

(22) PCT Filed: Aug. 5, 2005
(86) PCT No.: PCT/EP05/08506

§ 371 Date: Jan. 30, 2007

(30) Foreign Application Priority Data
Aug. 16, 2004 (EP) 04019394.8

(51) Int. Cl. G04B 19/26

(52) U.S. Cl. 368/15

(57) ABSTRACT

In order to display alternately various parameters in the same aperture (46) of a dial or possibly in distinct apertures, the watch is provided with a rotating display disc (51) which includes a series (60) of numbers, representing the dates (1-31) on one part of its circumference and, on the rest of the circumference, at least one image of a celestial body, for example the moon (62) and/or the sun, and optionally other symbols (64). Over time, this image is set in different positions in the aperture, to represent the phases of the moon or the rising and setting of the sun. In an electronic watch, the display disc is preferably driven by an electric motor (54) via a large reduction gear (56).

### BACKGROUND OF THE INVENTION

The present invention concerns a watch comprising a rotating display disc, fitted with a series of numbers for displaying a date in an aperture, and drive means for rotating the disc, and wherein the display disc carries said series of numbers on one part of its circumference and at least one symbol arranged on another part of the disc so that it can appear in said aperture or in another, the drive means being capable of producing angular movements of the display disc with different amplitudes depending upon whether said series of numbers or said symbol are displayed.

It has been common for a long time to make watches displaying the phases of the moon in an aperture and the date in another aperture. With this two aperture arrangement, the moon disc and the date disc partially overlap, which increases the thickness of the construction. It is of course possible to reduce the thickness by placing the moon disc within the annular date disc and in the same plane, but the diameter of the moon disc must then be greatly reduced and the moon phase display becomes very small. Other methods of overcoming this drawback exist, for example replacing one of the discs with a hand indicator as provided by CH Patent No. 657 740, however the dial becomes much more cluttered and less attractive than with aperture displays.

EP Patent No. 735 442 proposes an electronic timepiece using a date display disc for displaying alternately, in the same aperture of the watch dial, the date or another piece of information that depends on the time, for example the day of the week. For this purpose, the series of dates and the symbols representing this other information are arranged on respective portions of the same circumference of the display disc. Each symbol only appears in the aperture in one position, as in a usual display using separate discs.

### SUMMARY OF THE INVENTION

A basic idea of the present invention is using the date disc for displaying either the date or a momentary feature of a celestial body (phase of the moon, sunrise or sunset, etc.). More particularly, the invention proposes a watch of the type stated in the preamble hereinbefore, characterized in that said symbol arranged on the display disc is an image of a celestial body and in that the drive means are arranged for placing said image in several different positions in the aperture where it appears.

With this arrangement, the watch uses the display disc for displaying the date in a first operating mode and the celestial body image in another operating mode, called here the astronomy mode. The celestial body in question may be the moon, the position of its image in the aperture being altered each day in order to represent the current phase of the moon. Alternatively, or by way of complement, the celestial body in question may be the sun, the position of its image in the aperture representing during a day the rising, position in the sky and setting of the sun. The aperture for displaying the celestial body image can be either the aperture used for displaying the date, or a separate aperture.

This principle can be easily implemented in an electronic watch, particularly with means for driving the display disc that comprise an electric motor and a gear reducer, but it can also be achieved in a mechanical watch.

Other features and advantages of the invention will appear from the following description of various embodiments, given by way of non-limiting example with reference to the annexed drawings.

### BRIEF DESCRIPTION OF THE DRAWINGS

FIG. 1 is a schematic frontal view of a wristwatch provided with a display device according to a first embodiment of the invention and shows an operating mode in which the device display the phase of the moon.

FIG. 2 shows a mode in which the watch of FIG. 1 displays the date.

FIG. 3 is an enlarged frontal view showing the main elements of the date and moon phase display device.

FIG. 4 is a similar view to FIG. 1, showing another embodiment, with display of the sunrise.

FIG. 5 shows a mode in which the watch of FIG. 4 displays the date.

FIG. 6 shows an embodiment of the aperture that can be used instead of that of FIGS. 4 and 5, with display of the sunrise.

FIG. 7 shows the display of the date in the aperture of FIG. 6.

FIG. 8 shows a variant of the watch of FIG. 1, in a mode in which the moon phase is displayed.

FIG. 9 shows the display disc of the watch of FIG. 8.

### DETAILED DESCRIPTION OF VARIOUS EMBODIMENTS OF THE INVENTION

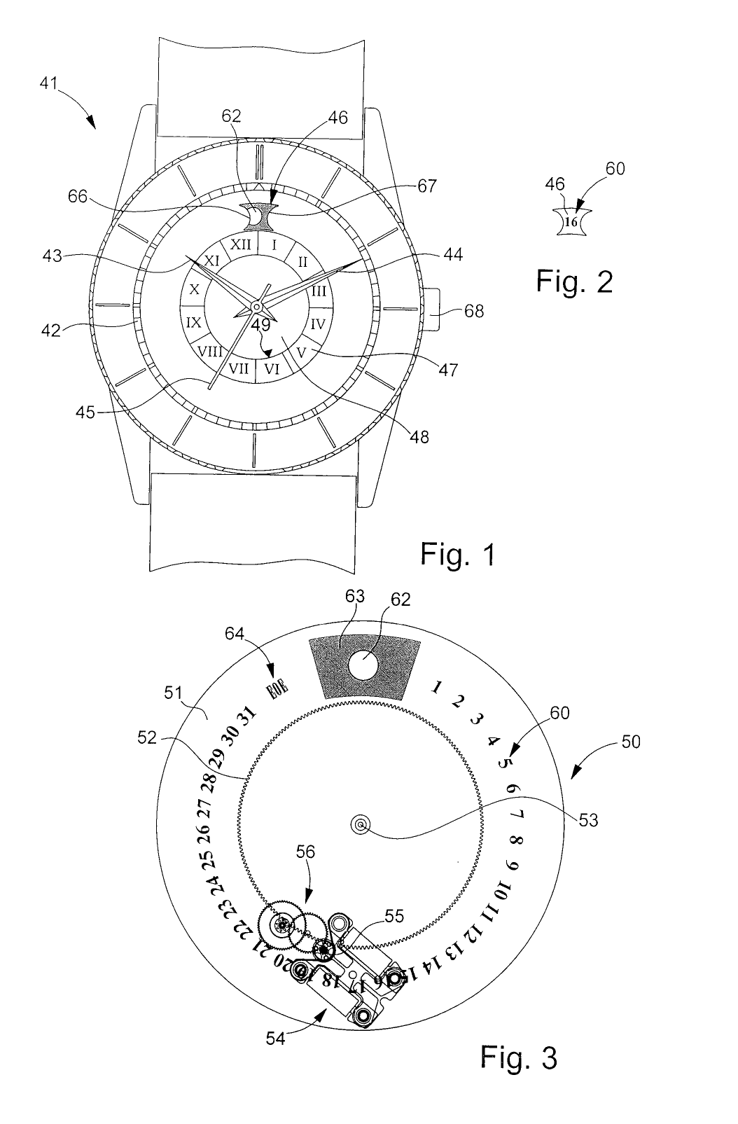

Wristwatch 41 illustrated by FIGS. 1 to 3 is an electronic analogue display watch with several electric motors. The time display is achieved on a dial 42 by means of an hour hand 43, a minute hand 44 and a seconds hand 45, these three hands being able to be driven by a single motor or by several if it is a multi-function watch. The watch further includes means for displaying the phase of the moon in an aperture 46 arranged in dial 42, and calendar display means which indicate the date in the same aperture 46 and the number of the month on a fixed scale 47 of dial 42 by means of a rotating central disc 48 fitted with an index 49.

The display in aperture 46 is achieved by means of the display device 50 schematically shown in FIG. 3. This device comprises a display disc 51 fixed to a toothed wheel 52 rotating about the centre 53 of the dial, a two-directional electric stepping motor 54, having a rotor 55, and a gear reducer 56 connecting rotor 55 to wheel 52 with a very small transmission ratio, for example around 1:1000 in the present case. The choice of this ratio depends in particular upon the size of the aperture 46 and the display elements featured on disc 51. Of course, display device 50 is associated with control means comprising a motor drive circuit and logic circuits associated with the watch movement of the electronic watch. It will be noted that a piezoelectric motor, also called an ultrasonic motor, could replace the stepping motor.

Rotating display disc 51 is combined in the present case for displaying three distinct parameters in turn in aperture 46, namely:

the date owing to a row 60 of dates 1 to 31, arranged at equal or unequal intervals over only one part of the circumference of disc 51 and sufficiently spaced apart that only one of them appears at a time in aperture 46;

the moon phase by means of a light circular image 62 of the moon on a dark background 63;

the “end of life” state or discharge of the electric battery of the watch, by means of a conventional symbol 64 such as EOE (end of energy) or any other clearly recognisable graphic element.

Of course, the three groups of display elements 60, 62 and 64 are sufficiently spaced apart from each other so that two of them cannot appear at the same time in aperture 46. This aperture comprises two convex edges 66 and 67 arranged for “biting” in turn one part of the circular image 62 of the moon, whereas the minimum distance between them corresponds to the diameter of image 62 so that the full moon can be indicated when image 62 is just between them.

The operation of the display device described hereinbefore includes two modes which are controlled by the user, for example by switching using a push-button or a control crown 68 of the watch, and a third automatic mode consisting in displaying the discharged battery state by means of symbol 64. The first controlled mode is that shown in FIG. 1, i.e. an astronomy display mode consisting in displaying the moon phase in aperture 46 by means of moon image 62, set in a position that corresponds to the age of the moon. The logic circuits of the watch can control for example a small movement of this image per day at a fixed time, the origin of the movements (the day of the new moon) being determined from a ephemerid table. The amplitude of movement from one new moon to the next obviously corresponds to twice the diameter of image 62, corresponding to an angle of approximately 20 degrees in the example shown. Consequently, if one uses an electric motor actuated at a rate of one half revolution of the rotor per day, the minimum reduction in order to rotate disc 51 by 0.67 degrees per day is approximately 1:270. With a larger image of the moon, this ratio could be brought down to approximately 1:180. In the present example, a larger reduction has been selected for several reasons: the step of the motor represents one complete rotor revolution, the daily movements for the date display are not the same depending upon whether the date comprises one or two figures, and finally a large reduction is desirable because of the inertia of the mobile masses of display device 50.

The second display mode is the calendar mode, in which one of dates 1 to 31 is displayed in aperture 46 as shown in FIG. 2, while index 49 is indicating the month on scale 47. The change of date can be achieved in the conventional instantaneous manner at midnight, by rotating disc 51 by the appropriate number of steps of motor 54. This number of steps can vary depending upon whether the date comprises one or two figures and even depending upon the width of the figures, the date 11 for example, being able to occupy less place on the disc than the date 25.

According to another method, instead of being moved forward once per day, the moon image 62 could be moved forward at fixed intervals corresponding to a fraction of the duration of a lunation, this fraction being selected to correspond to an integer number of steps of motor 54.

Each of the first and second display modes can be permanent. However, the watch can also be arranged so as to permanently display normally one of these modes, for example the date display, and to pass to the other mode only temporarily, when the user actuates a control such as a push-button.

The third display mode is the automatic indication of the discharged battery state. In this state, the date or moon phase display is automatically suppressed and motor 54 is operated so that it brings the symbol EOE 64 in a fixed manner into aperture 46 until the battery voltage returns to a normal value.

Another display mode, instead of the third mode or in addition thereto, could consist in displaying in aperture 46 a function symbol located in the place of or next to state symbol 64, to indicate temporarily for example a particular function switched on by the user or by a professional carrying out maintenance.

The applications of the invention are not limited to the example described hereinbefore, but can extend to other indications as an alternative to the lunar and date indications. For example, if one uses a “large date” type date display, comprising a display disc for the units and a display disc for the tens of the date, moon image 62 could be provided on the units disc and appear in the aperture while the tens disc displays a blank.

It will also be noted that the drive means for the combined date and moon disc do not have to be electric, since one could devise a mechanical drive able to produce appropriate movements of the disc.

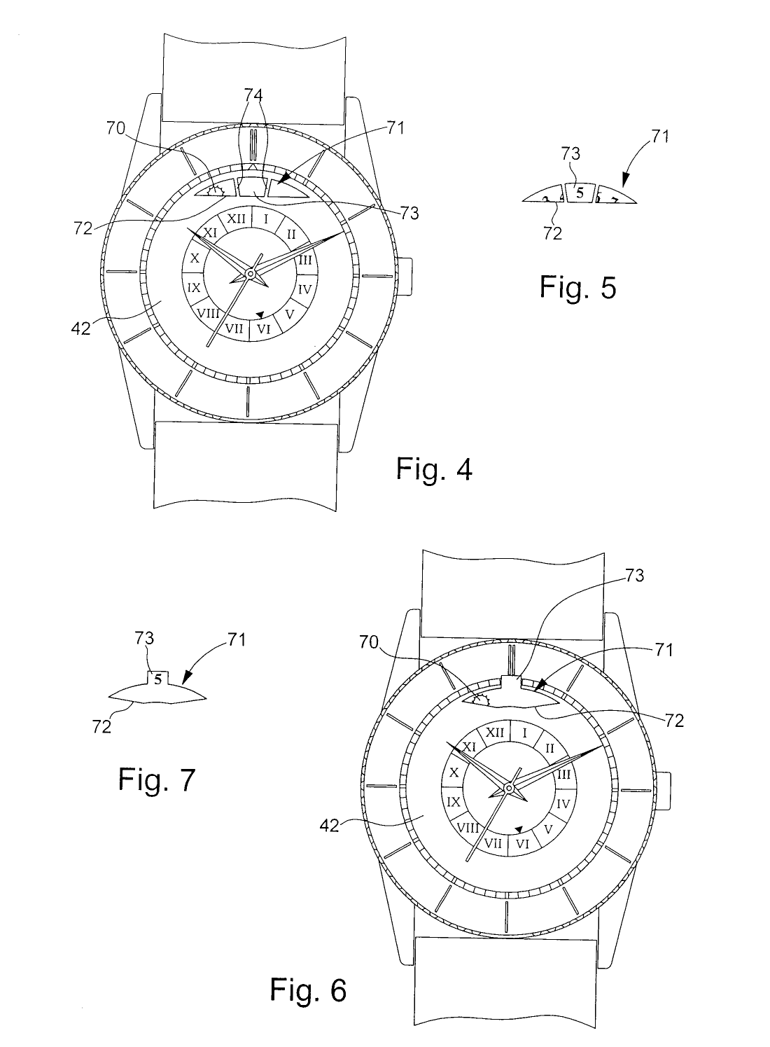

In the examples illustrated by FIGS. 4 to 7, the moon image of the preceding example is replaced by an image 70 of the sun on display disc 51. Aperture 46 is replaced by an aperture 71 that is of elongated shape horizontally, the bottom side 72 of which represents the horizon, whereas a central part 73 of the aperture is the right size for allowing a single date of disc 51 to be seen in the calendar display mode illustrated by FIGS. 5 and 7. In the examples of FIGS. 4 and 5, this central part 73 is delimited by two thin bars 74 and other dates can appear partially in the end zones of the aperture, the indications carried by disc 51 all being located at the same distance from the centre of the disc as in the case of FIG. 3. However, in the example of FIGS. 6 and 7, the central part 73 for reading the date is shifted radially outwards relative to the zone travelled by the sun image in the aperture, and the same radial shift between the series of dates and the sun image is provided on disc 51. thus, one can only see a single date at one time in the aperture.

FIGS. 4 and 6 illustrate the astronomy display mode, which represents the path of the sun in the sky via a movement of sun image 70 along aperture 71. The electronic circuits of the watch determine the position of image 70 in the aperture as a function of the current time, from the current date, ephemerid and algorithms stored in a watch memory, and data entered by the user to indicate the local time zone or longitude and latitude. In order to simulate the phases of sunrise and sunset in an attractive manner, where sun image 70 is intersected by the edge 72 representing the horizon, disc 51 is driven in rotation at a first, relatively high speed, since each of these phases lasts only a few minutes. Between these two phases, the discs rotates at a second, much lower speed than the first speed, to simulate the path of the sun in the sky during the day without it being necessary to make aperture 71 very long. Otherwise, the watch can operate as in the example of FIGS. 1 to 3.

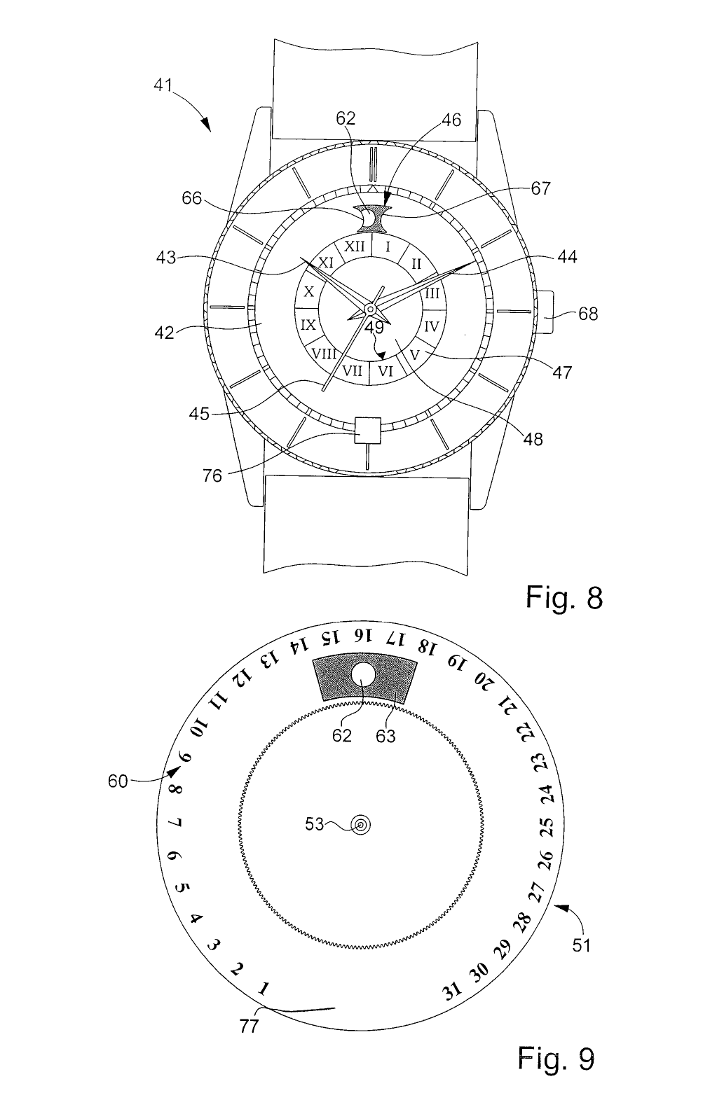

FIGS. 8 and 9 show a variant of watch 41 and the display disc 51 described hereinbefore with reference to FIGS. 1 to 3. The essential difference is that the date display occurs in an aperture 76 distinct from aperture 46, which is for the moon phase display. In the example shown, the date aperture 76 is placed at 6 o'clock in dial 42, but any other position could be envisaged, provided that the distance to the centre of rotation 53 of disc 51 is different from that of aperture 46 and moon image 62, so that this image cannot appear in aperture 76. Consequently, the row 60 of dates 1 to 31 is arranged on disc 51 at a distance from the centre 53 that differs from that of moon image 62, in this case the distance is greater so that there is more width for each date. In the gap between dates 31 and 1, there is a neutral field 77 which preferably has the same colour as the dial and which appears in aperture 77 in the astronomy display mode, i.e. while the dark field 63 is visible in aperture 46. Fields 63 and 77 are diametrically opposite on disc 51 in this example because apertures 46 and 76 are diametrically opposite.

Of course, the different aforementioned embodiments can be combined with each other, for example by adding the sun image 70 to display disc 51 next to field 63 containing the moon image, in particular for showing the sunrise and sunset in aperture 46 in a similar manner to that described with reference to FIGS. 4 to 7. In the astronomy display mode, the watch could thus display the sun during the day and the moon during the night.

1-13. (canceled)

14. A watch including a rotating display disc, provided with a series of numbers for displaying a date in an aperture, and drive means for rotating the display disc, and wherein the display disc carries said series of numbers on one part of the circumference thereof and at least one symbol arranged on another part of the disc so that said symbol appears in said same aperture, the drive means being able to produce angular movements of the display disc with different amplitudes depending upon whether it is said series of numbers or said symbol that is displayed,
wherein said symbol is an image of a celestial body and wherein the drive means are arranged for placing said image in several different positions in said aperture.

15. The watch according to claim 14, wherein said image is a substantially circular image of the moon and wherein the aperture in which it appears has a rectangular shape with convex ends, able to display a date, the ends of which being convex and mutually spaced apart by one time the diameter of the moon image.

16. The watch according to claim 14, wherein said image of a celestial body is an image of the sun and wherein the aperture in which said image appears has an elongated shape with at least one side representing the horizon.

17. The watch according to claim 16, wherein, when the sun image is in one or other of the end zones of said aperture, the display disc is driven in rotation at a first speed to simulate the rising or setting of the sun relative to the horizon and wherein, when the sun image is between the end zones of the aperture, the display disc is driven in rotation at a second speed, less than the first, to simulate the path of the sun in the sky during the day.

18. The watch according to claim 14, wherein at least one state or function symbol is also placed in the rest of said circumference of the display disc.

19. The watch according to claim 14, wherein the drive means for the display disc include an electric motor and a reduction gear (56).

20. The watch according to claim 19, wherein the reduction gear provides a transmission ratio, between the rotor of the motor and the display disc, of less than 1:180, and preferably close to 1:1000.

21. The watch according to claim 19, wherein the electric motor is a stepping motor.

22. The watch according to claim 14, wherein it includes a first display mode, in which the image of the celestial body is displayed in different positions in said aperture, a second display mode, in which the date is displayed in said aperture, and a manual control member enabling a user to pass from one display mode to another.

23. The watch according to claim 22, wherein it further includes a third display mode, in which a state or function symbol, placed in the rest of said circumference of the display disc, appears in the aperture instead of the date.
